(19) United States
(12) Patent Application Publication
(10) Pub. No.: US 2026/0167340 A1
(43) Pub. Date: Jun. 18, 2026

(54) AIRCRAFT PROPULSION SYSTEM COMPRISING A JET ENGINE, A MOUNTING PYLON AND MEANS FOR ATTACHING THE JET ENGINE TO THE MOUNTING PYLON

(71) Applicant: Airbus Operations SAS, TOULOUSE (FR)

(72) Inventors: Olivier PAUTIS, TOULOUSE (FR); Nicolas CHARTON, TOULOUSE (FR)

(21) Appl. No.: 19/416,405

(22) Filed: Dec. 11, 2025

(30) Foreign Application Priority Data
Dec. 13, 2024 (FR) FR2414105

(51) Int. Cl. B64D 27/40; B64D 27/18

(52) U.S. Cl. CPC B64D 27/402; B64D 27/18

(57) ABSTRACT

A propulsion system for an aircraft having a jet engine with a front casing with a rear face and a rear casing, a mounting pylon with a front portion and a lower spar to which a rear fitting is attached, a front engine mount attached between the front casing and the front portion, an arch with a base attached to the rear fitting and two arms, each having a first end secured to the base and a second end attached to the rear casing, two upper bars hinged to the rear face and to the arch, and two lower bars hinged to the rear face and to the arch, the two upper bars being rigidly attached to each other.

### CROSS-REFERENCES TO RELATED APPLICATIONS

This application claims the benefit of French Patent Application Number FR2414105 filed on Dec. 13, 2024, the entire disclosure of which is incorporated herein by way of reference.

### FIELD OF THE INVENTION

The present invention relates to the general field of attaching a jet engine beneath the wing of an aircraft. It notably involves a propulsion system comprising a jet engine, in particular a turbofan, a mounting pylon and means for attaching the jet engine beneath the mounting pylon. It also applies to an aircraft equipped with such a propulsion system.

### BACKGROUND OF THE INVENTION

A propulsion system of the prior art is attached beneath the wing of an aircraft. It comprises a jet engine and a mounting pylon via which the jet engine is attached beneath the wing. The mounting pylon has a rigid structure, which is also referred to as the primary structure, having attachment means for attaching the jet engine.

These attachment means are made up, among other things, of a front attachment for the jet engine, a rear attachment for the jet engine and a device for reacting the thrust forces generated by the jet engine.

The mounting pylon also has other attachment elements for attaching the mounting pylon to the wing.

Although such a structure is satisfactory, it is desirable to find an alternative arrangement which makes it possible, among other things, to establish an isostatic connection between the jet engine and the mounting pylon, while at the same time choosing the most suitable force paths for enhanced performance of the jet engine.

### SUMMARY OF THE INVENTION

An object of the present invention is to provide a propulsion system comprising a jet engine, a mounting pylon and attachment means for attaching the jet engine beneath the mounting pylon.

To that end, a propulsion system for an aircraft is proposed, said propulsion system comprising:
a jet engine extending around a longitudinal axis and having a vertical midplane containing the longitudinal axis and comprising a front casing with a rear face perpendicular to the longitudinal axis and a rear casing,
a mounting pylon having a rigid structure with a front portion and a lower spar to which a rear fitting is attached,
a front engine mount which is attached between an upper portion of the front casing and the front portion of the rigid structure,
an arch with a base hinged to the rear fitting and two arms arranged one on each side of the vertical midplane, each arm having a first end secured to the base and a second end hinged to the rear casing,
two upper bars arranged symmetrically one on each side of the vertical midplane, each bar being hinged to the rear face of the front casing via a first upper connecting point and to the arch via a second upper connecting point, the two upper bars being rigidly attached to each other, and
two lower bars arranged symmetrically one on each side of the vertical midplane, each bar being hinged to the rear face of the front casing via a first lower connecting point and to the arch via a second lower connecting point.

Such an arrangement makes it possible, among other things, to establish an isostatic connection between the jet engine and the mounting pylon.

Advantageously, the rear fitting and the arch lie in a single plane of integration perpendicular to the vertical midplane.

According to a first particular embodiment, the two upper bars are attached to each other by a plate attached between them between the first upper connecting points and the second upper connecting points.

According to a second particular embodiment, the two upper bars intersect on the vertical midplane and are attached to each other at this intersection.

Advantageously, the upper bars are attached horizontally and the lower bars are attached at an angle of between 45° and 70° with the rear face of the front casing, the lower bars extending down from the arch to the rear face of the front casing.

Advantageously, the base and the rear fitting are attached to each other not only by two rear connecting rods arranged symmetrically one on each side of the vertical midplane, each rear connecting rod being hinged to the rear fitting via a first connecting point and to the base via a second connecting point, but also, on the vertical midplane, via a third connecting point connecting the base and the rear fitting.

Advantageously, the rear connecting rods lie in the plane of integration.

Advantageously, the second end of each arm and the rear casing are attached to each other by two pairs of link rods arranged symmetrically for each pair, with one pair on each side of the vertical midplane, each link rod lying in a plane perpendicular to the longitudinal axis and each link rod being hinged to the second end of the arm that is on the same side via a first connecting point and to the rear casing via a second connecting point.

Advantageously, the link rods lie in the plane of integration.

Advantageously, for each pair of link rods, the two link rods are arranged symmetrically one on each side of a horizontal plane passing through the longitudinal axis.

Advantageously, the front engine mount has a front fitting attached to the front portion, two front connecting rods arranged symmetrically one on each side of the vertical midplane, and a vertical pin integral with the front fitting or with the front casing and fitted in a bore in the front casing or in the front fitting, respectively, each front connecting rod being hinged to the front fitting via a first connecting point and to the front casing via a second connecting point.

The invention relates to an aircraft having a propulsion system according to one of the above variants.

### BRIEF DESCRIPTION OF THE DRAWINGS

The aforementioned features of the invention, along with others, will become more clearly apparent on reading the following description of one exemplary embodiment, said description being given with reference to the appended drawings, in which:

FIG. 1 is a side view of an aircraft according to the invention,

FIG. 2 is a schematic representation, in perspective, of a propulsion system according to a first embodiment of the invention,

FIG. 3 is a schematic representation, in perspective, of a propulsion system according to a second embodiment of the invention,

FIG. 4 is a schematic representation, in a side view, of the propulsion system according to the first embodiment of the invention,

FIG. 5 is a sectional view along the line V-V in FIG. 4, and

FIG. 6 is a sectional view along the line VI-VI in FIG. 4.

### DETAILED DESCRIPTION OF THE PREFERRED EMBODIMENTS

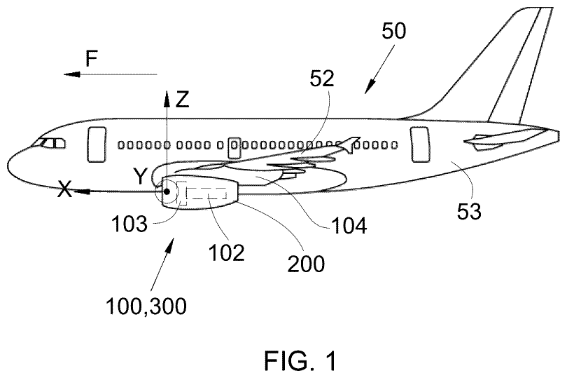

FIG. 1 shows an aircraft 50 that has a fuselage 53 on each side of which a wing 52 is attached. Attached beneath each wing 52 is a propulsion system 100, 300 according to the invention, the propulsion system comprising a mounting pylon 104 and a jet engine 102 which in this case is accommodated here in a nacelle 200. The invention applies in the same way to a jet engine 102 of the ultra-high bypass engine type. The propulsion system 100, 300 is attached to the wing 52 by the mounting pylon 104 and the jet engine 102 is attached beneath the mounting pylon 104.

By convention, X denotes the longitudinal axis of the jet engine 102, this axis X being parallel to a longitudinal direction of this jet engine 102 and to a longitudinal direction of the aircraft 50. Additionally, Y is the transverse axis of the jet engine 102, this axis being horizontal when the aircraft 50 is on the ground, and Z is the vertical axis or vertical height when the aircraft 50 is on the ground, these three axes X, Y and Z being mutually orthogonal.

Moreover, the terms “front” and “rear” are to be considered relative to a direction of forward movement of the aircraft 50 when the jet engine 102 is operating, this direction being schematically shown by the arrow F.

The jet engine 102 and the mounting pylon 104 are symmetrical overall with respect to a vertical midplane P (XZ) containing the longitudinal axis X and thus the vertical direction Z. The transverse axis Y is perpendicular to the vertical midplane P.

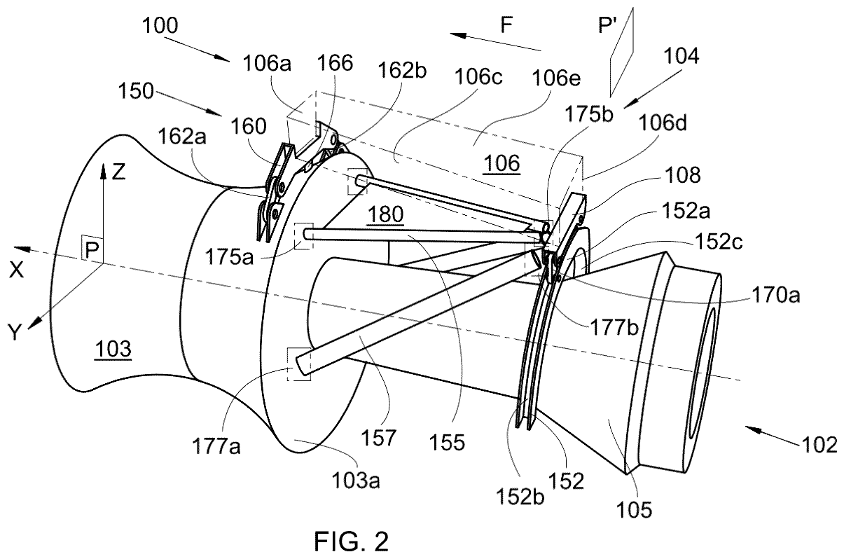

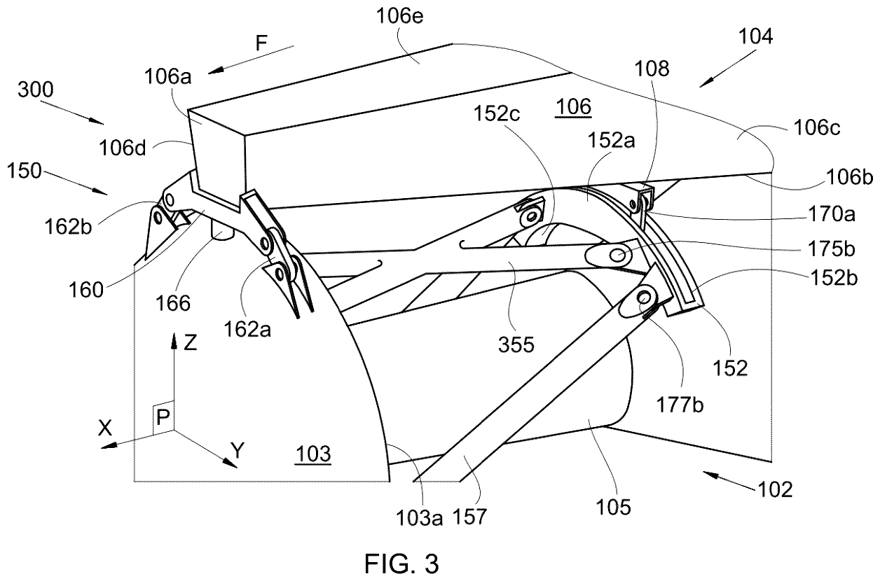

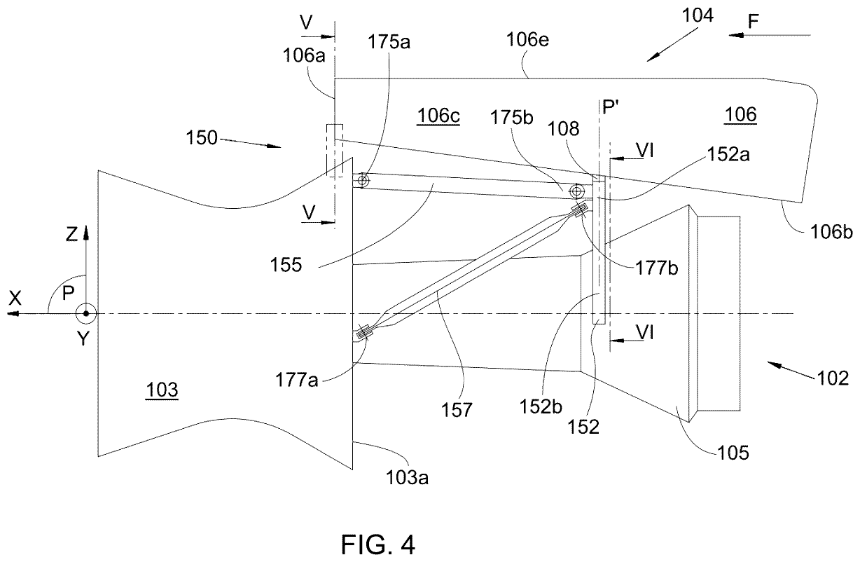

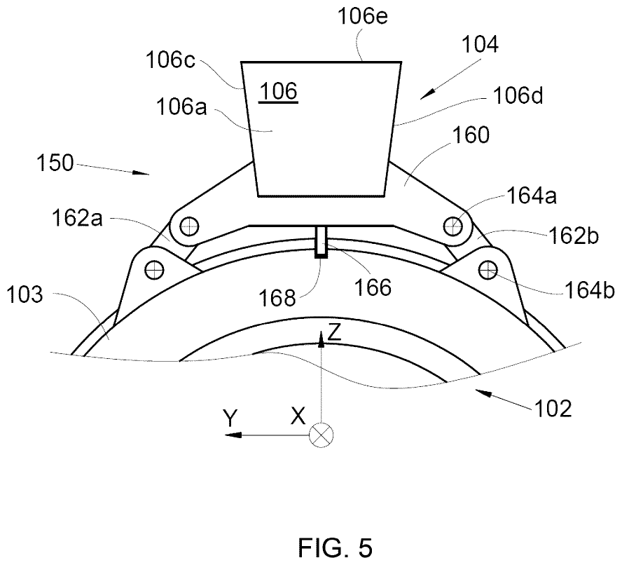

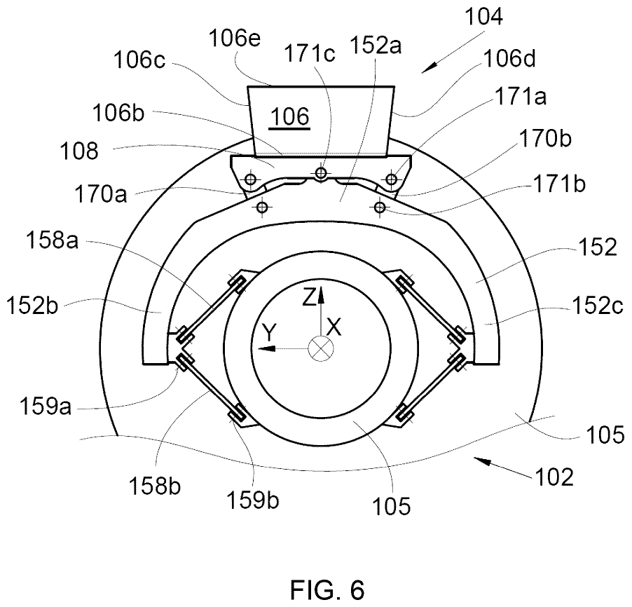

FIGS. 2 and 4 show the propulsion system 100 according to a first embodiment of the invention, FIG. 3 shows the propulsion system 300 according to a second embodiment of the invention and FIGS. 5 and 6 show implementation details for the propulsion system 100, 300.

The propulsion system 100, 300 comprises the jet engine 102 and the mounting pylon 104 which attaches the jet engine 102 to the wing 52. The mounting pylon 104 is represented here by its rigid structure 106, also referred to as primary structure, that is attached to the structure of the wing 52 by any suitable securing means known to those skilled in the art.

The rigid structure 106 takes the form of a box which has a front portion 106a, situated at the front of the rigid structure 106, a lower spar 106b extending below the rigid structure 106 and an upper spar 106e extending above the rigid structure 106. The rigid structure 106 also has two lateral walls 106c-d, one on each side of the vertical midplane P. These various spars and walls are attached to one another to form the rigid structure 106. The front portion 106a comprises for example a front wall and/or a portion of the lower spar 106b and of the lateral walls 106c-d.

The jet engine 102 comprises the following, from front to rear: a front casing 103 and a rear casing 105 which is attached to the rear of the front casing 103 and which accommodates elements of the jet engine 102, such as compression stages, a combustion chamber, turbine stages and an exhaust cone. The front casing 103 is for example a fan casing in which a fan of the jet engine 102 is mounted, but can also be the casing which is just to the rear of the fan if the jet engine is an ultra-high bypass engine.

The front casing 103 has a diameter greater than the diameter of the rear casing 105.

At the rear, the front casing 103 has a rear face 103a which is perpendicular to the longitudinal axis X and thus extends in a plane parallel to the plane YZ. The front casing 103 and the rear casing 105 form surfaces of revolution about the longitudinal axis X.

The propulsion system 100, 300 comprises a front engine mount 150 which attaches an upper portion of the front casing 103 to the front portion 106a of the rigid structure 106.

The propulsion system 100, 300 also comprises an arch 152 arranged around the rear casing 105 and to the rear of the rear face 103a of the front casing 103.

A rear fitting 108 is rigidly attached to the lower spar 106b beneath the rigid structure 106.

The arch 152 has a base 152a which is hinged to the rear fitting 108. The arch 152 also has two arms 152b-c arranged one on each side of the vertical midplane P, i.e., symmetrically with respect to the vertical midplane P; there is a port-side arm 152b and a starboard-side arm 152c. Each arm 152b-c has a first end secured to the base 152a and a second end hinged to the rear casing 105. Each arm 152b-c may be an element attached to the base 152a or form a one-piece assembly with the base 152a.

In the embodiment of the invention shown in the figures, the two ends of each arm 152b-c of the arch 152 are respectively at 3 o'clock and 9 o'clock with respect to the longitudinal axis X. However, the positions of the second ends of each arm 152b-c of the arch 152 may be arranged at +/−45° with respect to these positions shown.

The propulsion system 100, 300 also comprises bars 155, 355 and 157 which are arranged symmetrically on either side of the vertical midplane P.

There are thus two upper bars 155, 355 which are arranged in the top portion of the front casing 103 and each of which is hinged to the rear face 103a of the front casing 103 via a first upper connecting point 175a and to the arch 152 via a second upper connecting point 175b.

The two upper bars 155, 355 are rigidly attached to each other, i.e. they are attached to each other directly and the two embodiments show two particular arrangements of this secured state.

There are also two lower bars 157 which are arranged beneath the upper bars 155 and each of which is hinged to the rear face 103a of the front casing 103 via a first lower connecting point 177a and to the arch 152 via a second lower connecting point 177b.

Seen from above, the upper bars 155 are on the inside in relation to the lower bars 157.

Each connecting point 175a-b, 177a-b for each bar 155, 355, 157 takes the form of a ball-joint connection for limiting the bending moments. The first connecting points 175a and 177a are not shown in FIG. 3 but they take the same form as those in FIG. 2.

Such a propulsion system 100, 300 thus makes it possible to establish an isostatic connection between the jet engine and the mounting pylon owing to the blocking of 6 degrees of freedom by the combination of the ball-joint connection and rigid connection between the upper bars 155, 355.

The rear fitting 108 and the arch 152 lie in a single plane of integration P′ which is perpendicular to the longitudinal axis X.

Fitting the bars 155, 355 and 157 in place makes it possible to create a compact structure.

In the embodiment of the invention shown in FIGS. 2 to 4, the upper bars 155, 355, i.e. the top bars, are attached horizontally and the lower bars 157, i.e., the bottom bars, are attached at an angle of between 45° and 70° with the rear face 103a of the front casing 103 and the lower bars 157 extend down from the arch 152 to the rear face 103a of the front casing 103. The first lower connecting point 177a is at 3 o'clock (or 9 o'clock) overall on the rear face 103a with respect to the longitudinal axis X. However, the positions of the first lower connecting point 177a of each lower bar 157 can be arranged at +/−45° with respect to the positions shown.

For the upper bars 155, 355, the upper connecting points 175a-b have a main axis of rotation which is perpendicular to the vertical midplane P and for the lower bars 157, the lower connecting points 177a-b have a main axis of rotation which is perpendicular to the axis of the lower bar 157 in question and parallel to the vertical midplane P.

Each connecting point 175a-b, 177a-b takes the form of a clevis connection in this case.

In the first embodiment of the invention, the two upper bars 155 are attached to each other by fitting a rigid and fixed plate 180 in place, for example by welding, between the two upper bars 155. The plate 180 extends horizontally overall and it is between the first upper connecting points 175a and the second upper connecting points 175b.

In the second embodiment of the invention, the two upper bars 355 intersect on the vertical midplane P and are attached to each other at this intersection. The two upper bars 355 thus form an X, the four arms of which are hinged. The two upper bars 355 are integral with each other in the middle of their lengths overall.

FIG. 6 more clearly shows an example of the attachment between the base 152a of the arch 152 and the rear fitting 108. This attachment is realized by two rear connecting rods 170a-b and by a third connecting point 171c which is a backup connecting point, i.e., it only activates if one of the rear connecting rods 170a-b fails.

The two rear connecting rods 170a-b are arranged symmetrically one on each side of the vertical midplane P and each rear connecting rod 170a-b is hinged to the rear fitting 108 via a first connecting point 171a and to the base 152a via a second connecting point 171b. Each connecting point 171a-b connected to the rear connecting rods 170a-b takes at least the form of a rotary connection, but preferably takes the form of a ball-joint connection for limiting the bending moments and each connecting point in this case has a main axis of rotation which is parallel to the longitudinal axis X.

In the embodiment of the invention shown here, the rear connecting rods 170a-b lie in the plane of integration P′.

The third connecting point 171c connects the base 152a to the rear fitting 108 and is arranged on the vertical midplane P. This third connecting point 171c takes at least the form of a rotary connection, but preferably takes the form of a ball-joint connection for limiting the bending moments and in this case has a main axis of rotation parallel to the longitudinal axis X.

Each connecting point 171a-c takes the form of a clevis connection in this case.

In the case of the third connecting point 171c, the pin of the clevis connection has a diameter slightly less than the diameter of the bores in which it is fitted such that it only comes into contact with said bores when necessary.

FIG. 6 also shows a particular embodiment of the attachment between the second end of each arm 152b-c and the rear casing 105. This attachment is realized by two pairs of link rods 158a-b, the pairs being arranged symmetrically one on each side of the vertical midplane P and each link rod 158a-b lying in a plane perpendicular to the longitudinal axis X which is also the plane in which the arch 152 lies.

Each link rod 158a-b is hingedly and removably attached to the second end of the arm 152b-c that is on the same side via a first connecting point 159a and to the rear casing 105 via a second connecting point 159b.

In this case, for each pair of link rods 158a-b, the two link rods 158a-b are arranged symmetrically one on each side of a horizontal plane passing through the longitudinal axis X, i.e. the plane XY. The symmetrical fitting in place makes it possible to position the rear casing 105 relative to the arch 152.

Each connecting point 159a-b connected to the link rods 158a-b takes at least the form of a rotary connection, but preferably takes the form of a ball-joint connection for limiting the bending moments and each of these connecting points 159a-b in this case has a main axis of rotation which is perpendicular to the axis of the link rod 158a-b in question and lies in a plane which is perpendicular to the longitudinal axis X and is also the plane in which the arch 152 lies.

Each connecting point 159a-b takes the form of a clevis connection in this case.

In the embodiment of the invention shown here, the link rods 158a-b lie in the plane of integration P'.

FIG. 5 more clearly shows an example of a front engine mount 150 implemented in the invention, but the engine mount 150 can have a different architecture.

The front engine mount 150 has a front fitting 160 attached to the front portion 106a and two front connecting rods 162a-b arranged symmetrically one on each side of the vertical midplane P. Each front connecting rod 162a-b is hinged to the front fitting 160 via a first connecting point 164a and to the front casing 103 via a second connecting point 164b. Each connecting point 164a-b connected to the front connecting rods 162a-b takes at least the form of a rotary connection, but preferably takes the form of a ball-joint connection for limiting the bending moments and each connecting point in this case has a main axis of rotation parallel to the longitudinal axis X. Each connecting point 164a-b takes the form of a clevis connection in this case.

The front engine mount 150 also has a connection of the “spigot” type with a pin 166 which extends vertically, i.e., parallel to the vertical axis Z, and lies in the vertical midplane P.

The pin 166 is integral with the front fitting 160 or with the front casing 103 and is fitted, as the case may be, in a bore 168 in the front casing 103 or in the front fitting 160.

The fit between the bore 168 and the pin 166 is such that there is no movement along the longitudinal axis X or along the transverse axis Y and there are only movements along the vertical axis Z.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A propulsion system for an aircraft, the propulsion system comprising:
a jet engine extending around a longitudinal axis and having a vertical midplane containing the longitudinal axis and comprising a front casing with a rear face perpendicular to the longitudinal axis and a rear casing;
a mounting pylon having a rigid structure with a front portion and a lower spar to with a rear fitting attached thereto;
a front engine mount attached between an upper portion of the front casing and the front portion of the rigid structure;
an arch with a base hinged to the rear fitting and two arms arranged, respectively, one on each side of the vertical midplane, each arm having a first end secured to the base and a second end hinged to the rear casing;
two upper bars arranged symmetrically one on each side of the vertical midplane, each bar hinged to the rear face of the front casing via a first upper connecting point and to the arch via a second upper connecting point, the two upper bars being rigidly attached to each other; and
two lower bars arranged symmetrically one on each side of the vertical midplane, each bar hinged to the rear face of the front casing via a first lower connecting point and to the arch via a second lower connecting point.

2. The propulsion system according to claim 1, wherein the rear fitting and the arch lie in a single plane of integration perpendicular to the longitudinal axis.

3. The propulsion system according to claim 1, wherein the two upper bars are attached to each other by a plate attached between the two upper bars between the first upper connecting points and the second upper connecting points.

4. The propulsion system according to claim 1, wherein the two upper bars intersect at an intersection on the vertical midplane and attach to each other at the intersection.

5. The propulsion system according to claim 1, wherein the two upper bars attached horizontally and the two lower bars attached at an angle of between 45° and 70° with the rear face of the front casing, and
wherein the two lower bars extend down from the arch to the rear face of the front casing.

6. The propulsion system according to claim 1, wherein the base and the rear fitting attach to each other by
two rear connecting rods arranged symmetrically one on each side of the vertical midplane, each rear connecting rod being hinged to the rear fitting via a first connecting point and to the base via a second connecting point, and
on the vertical midplane, via a third connecting point connecting the base and the rear fitting.

7. The propulsion system according to claim 6, wherein the rear fitting and the arch lie in a single plane of integration perpendicular to the longitudinal axis, and,
wherein the rear connecting rods lie in the single plane of integration.

8. The propulsion system according to claim 1, wherein the second end of each arm and the rear casing are attached to each other by two pairs of link rods arranged symmetrically for each pair, with one pair on each side of the vertical midplane, each link rod lying in a plane perpendicular to the longitudinal axis, and each link rod being hinged to the second end of the arm that is on the same side via a first connecting point and to the rear casing via a second connecting point.

9. The propulsion system according to claim 8, wherein the rear fitting and the arch lie in a single plane of integration perpendicular to the longitudinal axis, and,
wherein the link rods lie in the single plane of integration.

10. The propulsion system according to claim 8, wherein, for each pair of link rods, the two link rods are arranged symmetrically one on each side of a horizontal plane passing through the longitudinal axis.

11. The propulsion system according to claim 1, wherein the front engine mount has a front fitting attached to the front portion, two front connecting rods arranged symmetrically one on each side of the vertical midplane, and a vertical pin integral with the front fitting or with the front casing and fitted in a bore in the front casing or in the front fitting, respectively, each front connecting rod being hinged to the front fitting via a first connecting point and to the front casing via a second connecting point.

12. An aircraft comprising:
the propulsion system according to claim 1.
